(19) United States
(12) Patent Application Publication
(10) Pub. No.: US 2004/0068439 A1
(43) Pub. Date: Apr. 8, 2004

(54) Method for sending customised data to at least a person provided with a portable apparatus

(76) Inventor: Eric Elgrably, Casabalanca (MA)

Correspondence Address: Oliff & Berridge, P O Box 19928, Alexandria, VA, 22320, US

(21) Appl. No.: 10/450,302

(22) PCT Filed: Dec. 14, 2001
(86) PCT No.: PCT/IB01/02793

(30) Foreign Application Priority Data
Dec. 14, 2000 (GB) 0030506.0

(51) Int. Cl. G06F 17/60

(52) U.S. Cl. 705/14

(57) ABSTRACT

The present invention provides a method of sending personalized information to at least one person provided with a portable appliance (M) having a memory and suitable for exchanging information over a wireless connection or for reading information stored in said memory, said method comprising the following steps:

displaying the information by means of at least one display device distinct from the portable appliance and enabling different images to be displayed;

detecting the presence of said appliance (M) in a geographical zone;

during the presence of said appliance in said geographical zone, reading at least one item of information from the memory of the appliance, said item of information having been stored during an earlier use of the appliance or enabling the appliance to be identified; and

sending personalized information to the appliance of content that is a function of said at least one item of information read from the memory and of at least one item of information displayed on the display device, and/or storing the information read from the memories of appliances present in said geographical zone between two predetermined instants.

The present invention relates in particular to sending personalized information to at least one person provided with a portable appliance.

It is known to use vehicles such as buses or taxis as advertising media.

In large cities in particular, populations are not the same in all districts of the city, and any given advertising content will not necessarily have the same impact throughout the city.

There exists a need for a method of improving the dissemination of information, in particular advertising, for example on vehicles such as buses or taxis.

Furthermore, it is known to use advertising panels suitable for sending information to people close to the panels, or for receiving purchase orders, for example.

Such advertising panels transmit information independently of the profile of the person receiving the information.

There also exists a need to have a method enabling the impact of the information disseminated by an advertising panel to be known or to personalize the information sent to people who have become aware of information disseminated by the advertising panel.

The present invention seeks in particular to satisfy at least one of the above-specified needs by means of a method of sending personalized information to at least one person provided with a portable appliance having a memory and suitable for exchanging information via a wireless connection, the method comprising the following steps:

displaying information by means of at least one display device distinct from the portable appliance and enabling different images to be displayed;

detecting the presence of said appliance in a geographical zone, for example a geographical zone extending at least in the field of view in which the information displayed on the display device can be read visually;

while said appliance is present in said geographical zone, reading at least one item of information from the memory of the appliance, said information having been stored during prior use of the appliance or enabling the appliance to be identified; and

sending personalized information to the appliance, of content that is a function of said at least one item of information read from the memory and optionally of at least one item of information displayed on the display device and/or storing the information read from the memories of appliances present in said geographical zone between two predetermined instants.

The displayed information may comprise an advertising film or a reminder message about an applicable law.

By means of the invention as defined above, it is possible from the information read in the memory of a portable appliance, for example, to determine the centers of interest of a person or to know whether that person uses the appliance to make purchases remotely, for example. Thus, instead of sending non-personalized information to people in the above-mentioned geographical zone, it is possible to personalize the content of the information that is sent, for example by transmitting only information that is likely to be of interest to the person given that person's centers of interest. It is also possible to determine whether the person can be authorized to receive calls in the geographical zone, in particular when the zone is a theater or a hospital. The information sent may then cause certain appliances to be switched off, for example.

The above-mentioned geographical zone may depend on the location of the display device.

In a particular implementation of the invention, the information stored in the memory of the appliance was stored during a prior use of the appliance, for example when the appliance was outside the above-mentioned geographical zone.

The geographical zone may extend from a point that is fixed in time, or in a variant, it may vary over time.

In a particular implementation of the invention, the memory of the appliance is suitable for exchanging information over a wireless connection with a transmitter and/or a receiver when the appliance is in the above-mentioned geographical zone.

The appliance may be suitable for being connected to at least one server, said memory being capable of containing information sent by the server during an earlier connection of the appliance with the server. The earlier connection may have taken place over a connection that is wireless or otherwise. In the event of a wired connection, the information stored in the memory may contain cookies sent by a server, e.g. an Internet site.

The information stored in the memory of the appliance may include indications about the nature of sites, in particular Internet sites, visited in the past by means of said appliance, and said indications may comprise: a site identity, a site address, a reply to a questionnaire, the time and date of the connection, the duration of the connection, the speed of the connection, the nature of a method of payment used, the identity of the access supplier, the volume of data exchanged.

The information stored may also include indications concerning the nature of the operations, in particular purchases, performed with the appliance. These indications may, for example, include the address of the site where a purchase has been made, a specification of the product(s) purchased, the date of purchase.

The information may also include indications concerning the payment means used with the appliance to pay for purchases. By way of example, these indications may contain all or part of the information relating to a payment order sent in the past and authorizing the purchase amount to be deducted directly from an account, for example an account open with an Internet access provider or a mobile telephone operator.

The information stored in the memory may not contain any program that is executable by the appliance.

The information stored may also include a code capable of indicating whether or not the user of the appliance is authorized to receive calls in certain locations, for example in hospitals or in theaters.

The appliance may include a screen and may be selected from the following non-limiting list: a mobile telephone, a personal digital assistant (PDA), a portable computer, a mobile Internet terminal type appliance.

The information sent to the appliance may include at least one element selected from the following list: an image, alphanumeric characters, a link to an Internet site, and multimedia content transmitted in particular by streaming technology.

In an implementation of the invention, information in the memory of the appliance is caused to be read only after detecting a request sent by the appliance.

In another implementation of the invention, the information in the memory of the appliance is read independently of prior reception of a request sent by the appliance. Thus, reading may be performed while the appliance is in standby mode, for example.

The information stored in the memory of the appliance may also be independent of actions taken by the user on the appliance. In particular, when the appliance is a mobile telephone, the memory may be read regardless of whether or not the telephone is making a call.

The information may also be caused to be read independently of the user pressing a key of the appliance. This applies for example when reading is triggered automatically by detecting that a portable appliance has entered into a predetermined geographical zone.

The memory may comprise a hard disk, a CD ROM, a floppy disk, or an electronic memory, of the read/write type or of the read only type (RAM or ROM).

In a particular implementation of the invention, the length of time a portable appliance is present in the geographical zone may be determined as a function of the content displayed on the display device. Thus, it is possible to evaluate the degree of interest shown by the public in particular displayed content, depending on the shorter or longer length of time the portable appliance is detected as being present.

It is also possible to determine the length of time a portable appliance is present in the geographical zone as a function of the information read from the memory of the appliance, and possibly also as a function of the displayed content. Thus, for example, it is possible to determine the profile of people remaining longer in the geographical zone because they are captivated by the displayed content, and consequently to know the type of population on which the displayed content has the greatest impact. It is possible in this manner to determine, for example, whether the displayed content is more attractive to men or to women, to young people or to older people, or to people who use their portable appliances frequently, or only occasionally.

It is also possible to determine the number of portable appliances detected in the geographical zone during a predetermined period, so as to evaluate, for example, busy periods in the geographical zone, and to adapt the duration and the content of the displayed information accordingly, for example.

In an implementation of the invention, the travel speed of the appliances in the geographical zone is determined, e.g. by means of a camera, in order to determine the interest shown by the people present in the geographical zone in the displayed content, a person being liable to stop or slow down if the displayed content is of interest.

All or some of the above information can be stored and used for statistical processing. It is then possible subsequently to modify the displayed content as a function of the results of the statistical processing.

The display device may be stationary.

In a variant, the display device may be moved by means of a vehicle and the display device may be configured in such a manner as to be visible to pedestrians or motorists situated in the vicinity of the vehicle.

In an implementation of the invention, the display device displays differing advertising content depending on the location of the vehicle. By means of this aspect of the invention, it is possible to adapt the information, and in particular advertising information, to the characteristics of the population that inhabits or that travels in each zone through which the vehicle passes.

In a particular implementation of the invention, the vehicle is informed of its position by a satellite navigation system, such as the system known under the initials GPS, for example.

As the vehicle travels through a city, the city is advantageously subdivided into various zones as a function of the preponderance of certain socioeconomic characteristics in the population living or traveling in that zone, in particular purchasing power, religion, average age, customs. Different content, in particular advertising, is then displayed to match the characteristics of the population living or traveling in the zone being passed through.

At least some of the content, in particular advertising, can be recorded on a data storage device present in the vehicle.

In a variant, or additionally, at least some of the content, in particular advertising, is downloaded by the vehicle. In which case, the content, in particular advertising, can be downloaded almost in real time, with any given content being downloaded on coming up to or on passing through a zone in which it is to be displayed.

Thus, content, and in particular advertising, can be renewed and updated frequently.

In a particular implementation of the invention, determined content, in particular advertising, is displayed as a function of the time of day, since the population of a zone being passed through can vary over time, e.g. if it is a tourist zone or a business zone.

In a variant, or additionally, different content, in particular advertising, can be displayed as a function of the speed of the vehicle, so as to take account of the way perception of the content is modified by speed.

In particular, when the vehicle is stationary, it is possible to display specific content.

The duration for which each item of content is displayed can also be determined as a function of the speed of the vehicle.

The travel direction of the vehicle relative to the general traffic in the vicinity of the vehicle can also have an influence on the content for display, in particular advertising.

It is also possible to display different content, in particular advertising, as a function of traffic density, for example in order to take account of the influence of stress on the behavior of people.

Finally, when the vehicle is close to a given store, it is possible to display on the vehicle content, in particular advertising, relating to the goods or services offered by the store.

For this purpose, the store in question can be provided with a transmitter terminal, for example, suitable for informing the vehicle that it is close by.

In a particular implementation of the invention, signals are transmitted from transmitter terminals placed along the route of the vehicle to control the display of different items of content, in particular advertising, various items of content being specific to respective terminals.

It is possible for the display of content, in particular advertising, to be associated with an indication enabling people to obtain additional information about the subject matter of the displayed content.

Such an indication advantageously includes an Internet address.

Thus, any person perceiving advertising and interested by its subject matter can obtain additional information about the goods or services in question by connecting to the Internet site whose address is displayed.

Under such circumstances, data can be transferred between the appliance and a server using one of the technologies known under the initials WAP, GPRS, 3G, CDMA 2000, or W-CDMA, for example.

In a particular implementation of the invention, a person looking at an item of content, in particular advertising, is given the option of causing additional information to be displayed on the display device of the vehicle by sending a suitable request, in particular from a mobile telephone or a pocket computer.

In a variant, or in addition, data relating to the displayed content can be transferred by radio from the vehicle to an appliance situated within radio range of the vehicle, in particular a mobile telephone or a pocket computer.

Under such circumstances, data transfer is preferably implemented using the “Bluetooth” standard, which gives a range of about 10 meters (m).

In a particular implementation of the invention, people looking an item of content, in particular advertising, can be given the option of sending information to the vehicle, e.g. by means of the mobile telephone or a portable computer, in order to make an order directly and/or to give personal details.

The invention also provides, in another aspect, a method of displaying information, in particular advertising information, on a vehicle, the method being characterized by the fact that it comprises the following steps:

fitting the vehicle with a display device arranged to be visible to pedestrians or motorists situated in the vicinity of the vehicle; and

displaying content, in particular advertising content, that differs depending on the location of the vehicle.

In another of its aspects, the invention also provides a method of displaying information, in particular advertising information, on a vehicle, the method being characterized by the fact that it comprises the following steps:

fitting the vehicle with a display device arranged to be visible to pedestrians or motorists situated in the vicinity of the vehicle;

displaying content, in particular advertising content, that differs depending on the location of the vehicle; and

enabling people perceiving content, in particular advertising content, to send information to the vehicle, e.g. by means of a mobile telephone or a portable computer, in order to make an order directly and/or send their details.

The invention also provides a method of displaying information, in particular advertising information, on a vehicle, the method being characterized by the fact that it comprises the following steps:

fitting the vehicle with a display device arranged to be visible to pedestrians or motorists situated in the vicinity of the vehicle;

displaying content, in particular advertising content, that differs depending on the location of the vehicle; and

enabling a person perceiving the content, in particular advertising content, to cause additional information to be displayed on the display device of the vehicle, by sending an appropriate request, in particular from a mobile telephone or a pocket computer.

The invention also provides a method of displaying information, in particular advertising information, on a vehicle, the method being characterized by the fact that it comprises the following steps:

fitting the vehicle with a display device arranged to be visible to pedestrians or motorists situated in the vicinity of the vehicle;

displaying content, in particular advertising content, that differs depending on the location of the vehicle; and

causing the displayed content to vary as a function of the speed of the vehicle, in particular by varying the length of time it is displayed and/or the size of the image displayed.

In another of its aspects, the invention also provides a method characterized by the fact that it comprises the following steps:

sending a request by means of a portable appliance;

locating the portable appliance while the request is being sent;

receiving the request on a vehicle including a display device; and

displaying on the display device content that is a function of at least one item of information contained in a memory of the portable appliance.

By way of example, the vehicle may be a taxi and the display device may be fixed on a door of the vehicle or disposed inside it, for example.

When a person calls the taxi by means of the portable appliance, advertising can be displayed that is a function of information read from a memory of the portable appliance. This advertising may thus be selected as a function of the profile of the passenger, thereby improving the impact of the advertising. For example, the language of the advertising may be selected as a function of the nationality of the carrier of the portable appliance, as determined from information read in the memory of the appliance.

The vehicle receiving the request may, for example, be that one of a fleet of vehicles that is geographically closest to the portable appliance and available for taking passengers.

The invention also provides apparatus for sending personalized information to at least one person provided with a portable appliance having a memory and suitable for exchanging information by a wireless connection, said apparatus comprising:

a display device for displaying information, in particular advertising information;

a reader device enabling at least one item of information contained in the memory to be read while the appliance is present in a geographical zone, for example a geographical zone extending at least in the field of view in which the information displayed on the display device can be read visually; and

a transmitter suitable for sending personalized information to the appliance, of content that is a function of said at least one item of information read from the memory and of at least one item of information displayed on the display device.

The apparatus may further comprise a detector to detect the presence of the portable appliance in the field of view in which information displayed on the display device can be read visually.

The display device may be stationary.

In a variant, the display device may be arranged for fitting on a vehicle so as to be easily visible to pedestrians or motorists situated in the vicinity of the vehicle.

The above-mentioned apparatus may include a control device for the display device enabling content to be displayed, and in particular advertising content, that differs as a function of the geographical position of the vehicle.

In a particular embodiment, the display device comprises at least a video screen, e.g. a plasma screen, a CRT, or a liquid crystal display.

In a variant, or in addition, the display device comprises at least one microcapsule screen.

The display device can also have at least one scrolling screen.

Preferably, the apparatus includes a satellite navigation device, e.g. using the navigation system known under the initials GPS.

The apparatus may include an optical, electronic, or magnetic medium on which various items of content, in particular advertising, can be or are stored, the control device being arranged to cause a given item of content to be displayed on the display screen on receiving a specific control signal.

When the display device is fitted on a vehicle, the specific control signal can be issued automatically by a navigation device on board the vehicle.

In a variant, the specific control signal can be issued from outside the vehicle, e.g. by one or more transmitter terminals placed at one or more predetermined locations on the route of the vehicle.

Advantageously, the apparatus includes a receiver enabling an item of content, in particular advertising, to be downloaded.

The displayed advertising content can be silent, with the apparatus having no audio means.

Advantageously, the display device includes at least one screen of dimensions that are large enough to enable it to be visible to pedestrians or motorists in the above mentioned geographical zone within a radius of at least 5 m and preferably, and advantageously, of at least 10 m.

Such a screen preferably has an area lying in the range 0.1 m² to 15 m², and more preferably lying in the range 1 m² to 10 m².

When the display device is fitted on a vehicle, the control device can be arranged to modify the displayed content, in particular advertising, as a function of the speed of the vehicle, for example to display information that is clearly visible in spite of vehicle speed when the vehicle is traveling fast, but when the vehicle is traveling more slowly, to display content that is denser, requiring sustained attention to be seen in detail.

The transmitter may operate by using the “Bluetooth” standard, for example.

The apparatus may also include a receiver suitable for receiving a signal transmitted by a mobile telephone or a portable computer for the purpose of making an order or of requesting the display of additional information, for example.

In a particular embodiment of the invention, the above-mentioned control device can be arranged to allow the display only of content that satisfies predetermined conditions.

When the display device is fitted on a vehicle, if the motorist so desires, the motorist can authorize the display of advertising content relating to one or more predetermined topics only, e.g. as a function of the motorist's own political, moral, or religious convictions.

In a particular embodiment of the invention, the apparatus includes at least one video sensor connected to an image processor device for counting the number of times the screen is looked at, and the length of time it is looked at, or a counter for determining the number of requests sent to the vehicle from a portable appliance, e.g. a mobile telephone or a portable computer.

The control device may also be suitable for selecting which content, in particular advertising, to display as a function of nearby transmitters, such as mobile telephones, in particular on recognizing subscriptions that have been taken out by the owners of mobile telephones in the above-mentioned geographical zone.

The control device may also be connected to means for detecting the approach of a pedestrian and/or a motorist for triggering the display of an item of content, in particular advertising.

The control device may also be connected to a sensor for sensing ambient light level so as to adapt the brightness and/or the contrast of the screen to ambient light.

In another of its aspects, the invention also provides apparatus for installing on a vehicle to display information, in particular advertising, the apparatus being characterized by the fact that it comprises:

a display device arranged to be easily seen by pedestrians or motorists situated in the vicinity of the vehicle; and

a control device for controlling the display device, and enabling different content, in particular advertising, to be displayed as a function of the geographical position of the vehicle.

In another of its aspects, the present invention also provides a system enabling information, in particular advertising, to be displayed, the system being characterized by the fact that it comprises:

at least one vehicle fitted with display means arranged to be easily visible to pedestrians or motorists situated in the vicinity of the vehicle, and a control device for controlling said display device, enabling different content, in particular advertising, to be displayed automatically as a function of the geographical position of the vehicle;

at least one transmitter external to the vehicle, enabling the control device to cause different content to be displayed in response to a change in the position of the vehicle; and

at least one receiver suitable for receiving a signal transmitted by a mobile telephone or a portable computer in order to place an order or request the display of additional information.

In a particular embodiment, the external transmitter is on board a satellite.

In another particular embodiment, the external transmitter is a relay in a mobile telephone network.

The external transmitter can also be a local transmitter terminal, specific to the system.

Advantageously, the system also includes an Internet or voice server enabling a person who has seen an item of content, in particular advertising, to obtain additional information thereon.

In a particular embodiment, the system includes a transmitter external to the vehicle enabling different content for display to be sent to the vehicle.

In another of its aspects, the invention also provides a method of selectively preventing the users of portable appliances such as mobile telephones, for example, from using their appliances in certain premises, for example in a theater or in a hospital, while still enabling certain priority users such as doctors or the police to receive emergency calls, where appropriate.

This method comprises the following steps:

detecting the presence of a portable appliance in a predetermined geographical zone;

reading an item of information in a memory of the appliance, said item of information making it possible to determine whether or not the portable appliance is a priority appliance;

if the portable appliance is not a priority appliance, performing an action enabling call reception to be prevented; and

if the appliance is a priority appliance, authorizing call reception.

The action undertaken when the portable appliance is a non-priority appliance may be to send information causing a message to be displayed on a screen of the appliance specifying that call reception is inhibited or sending information that causes the appliance to be switched off.

The information sent to the portable appliance may depend on the content displayed on a display device, for example a cinema screen. Thus, before the film starts, the information sent to a non-priority portable appliance may be a message indicating that call reception will be inhibited while the film is playing. When the film is about to begin, the information sent to the portable appliance will make it impossible for non-priority appliances to receive calls.

Other characteristics and advantages of the present invention appear on reading the following detailed description of non-limiting embodiments, and on examining the accompanying drawings, in which:

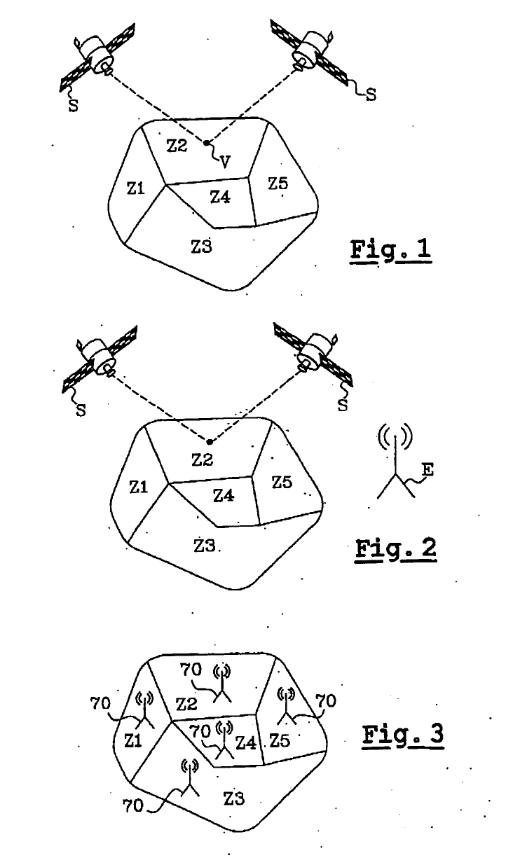

FIG. 1 is a diagrammatic map of a city subdivided into a plurality of zones with vehicle position being identified in the city by a satellite navigation system;

FIG. 2 shows advertising content being downloaded by the vehicle;

FIG. 3 shows the use of specific terminals;

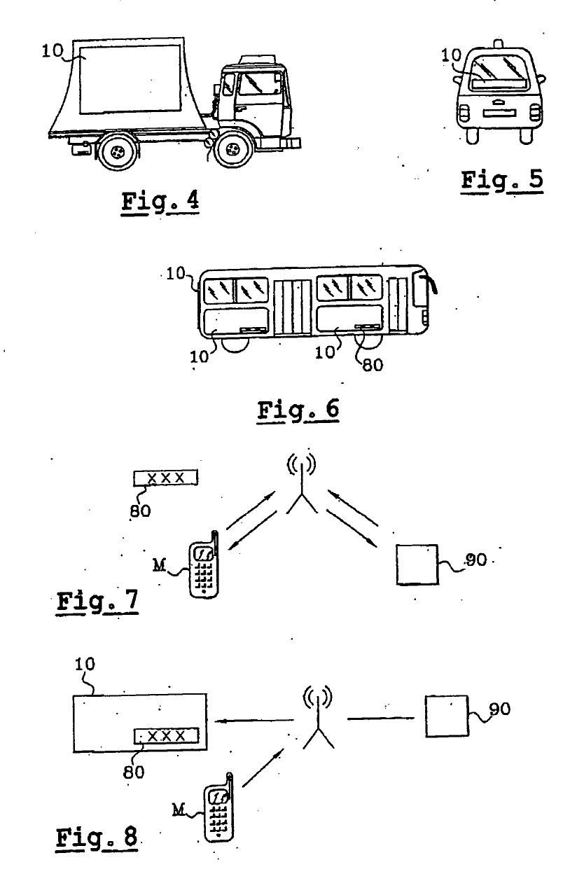

FIG. 4 is a diagram of an advertising vehicle fitted with a display device of the invention;

FIG. 5 is a diagram of a car fitted with a display device of the invention;

FIG. 6 is a diagram of a bus fitted with a display device of the invention;

FIG. 7 shows the use of a mobile telephone by a person situated in the vicinity of the vehicle to obtain additional information about the displayed advertising;

FIG. 8 shows the displayed content being modified as a function of a request sent from a mobile telephone situated in the vicinity of the vehicle;

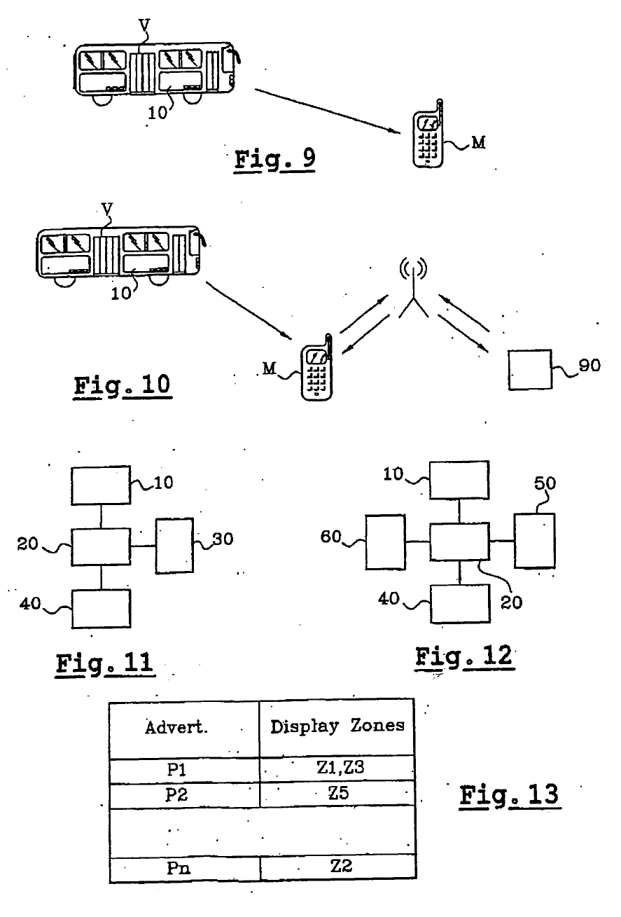

FIG. 9 shows the downloading of data transmitted by the vehicle to the mobile telephone of a person situated in the vicinity of the vehicle;

FIG. 10 shows the downloading of data transmitted by the vehicle to the mobile telephone of a person situated in the vicinity of the vehicle, and then data being interchanged between the mobile telephone and a server;

FIG. 11 is a diagram showing apparatus for implementing the method;

FIG. 12 is a diagram showing variant apparatus;

FIG. 13 is a table showing how each item of advertising content is associated with one or more geographical zones;

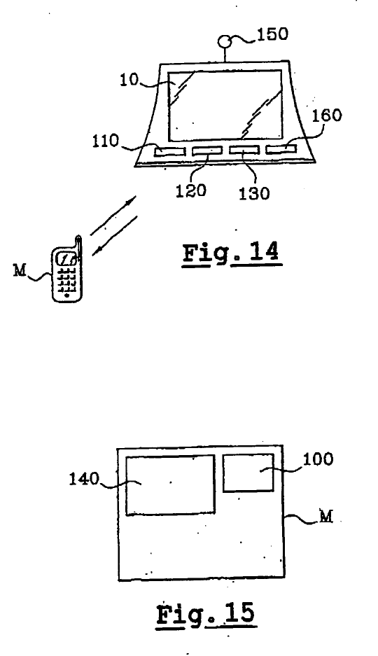

FIG. 14 is a fragmentary diagram of a stationary display device and a mobile telephone suitable for exchanging information; and

FIG. 15 is a fragmentary and highly diagrammatic representation of the various elements of a portable appliance such as a mobile telephone.

FIG. 1 is a diagram showing various zones Z₁, Z₂, . . . , Z₅ of a city, with the city being subdivided on socioeconomic criteria, zone Z₁ corresponding, for example, to a fashionable area, zone Z₂ being mostly inhabited by a low-income population, zone Z₃ by the middle classes, zone Z₄ being a business district, and zone Z₅ being inhabited mostly by students.

The number of zones is set at five purely by way of example and naturally this number can differ without thereby going beyond the ambit of the present invention.

The location of a vehicle V is represented by a point, the vehicle being one of the vehicles shown in FIGS. 4 to 6, for example.

FIG. 1 also shows satellites S forming part of the navigation system known under the initials GPS and enabling the location of the vehicle V to be identified.

The vehicle V carries a display device 10 which can be of various forms, for example it can be in the form of one or more giant screens when the vehicle is a truck, as shown in FIG. 4, or a luminous strip when the vehicle is a taxi or minicab as shown in FIG. 5, or a plurality of medium-sized screen when the vehicle is a bus, as shown in FIG. 6.

The screens can be video screens, e.g. cathode ray tubes (CRTs.), plasma screens, or liquid crystal displays (LCDs), or screens using microcapsule technology as described, for example, in U.S. Pat. No. 6 017 584.

The screens can also be scrolling screens of the kind commonly used for advertising at fixed locations.

The display device 10 is connected to control means 20 shown diagrammatically in FIG. 11, and arranged, in accordance with the invention, to modify the displayed content as a function of the position of the vehicle V.

The control means 20 are connected to a data storage device 30 such as a hard disk, an optical disk, an electronic memory, or a magnetic tape, and to a position-determining device 40 that delivers information to the control device 20 concerning the position of the vehicle as determined by means of the satellites S.

Depending on the information supplied by the position-determining device 40, the control device 20 selects determined advertising content from the storage means 30.

By way of example, when the position-determining device 40 informs the control device 20 that the vehicle V is in the fashionable zone Z₁, the control device selects advertising content from the storage means 30 matching the purchasing power of the population living in the zone Z₁, for example relating to luxury goods.

The program for selecting advertising content as a function of vehicle location is defined in advance in this example.

When the position-determining device 40 informs the control device 20 that the vehicle V is in zone Z₂ occupied for the most part by a population having low purchasing power, the control device 20 selects suitable advertising content from the storage means 30, e.g. relating to consumer goods.

Each of the items of advertising content P₁, . . . P₁₁ stored in the storage means 30 is associated with information specifying the zones in which it is to be displayed, as shown in FIG. 13.

In the example of FIG. 11, the storage means 30 are on board the vehicle and travel with it.

It would not go beyond the ambit of the present invention for the vehicle to be fitted with a receiver enabling advertising content to be downloaded.

By way of example, FIG. 12 shows on-board apparatus in which the storage means 30 are replaced by a receiver 50 thus making it possible to download different advertising content in real time or prior to vehicle departure. In which case, the on-board apparatus advantageously includes a buffer memory enabling downloaded content to be stored prior to being applied to display device 10.

By way of example, downloading can be performed using an external transmitter E capable of covering all of the zones Z₁, . . . , Z₅ through which the vehicle passes, as shown in FIG. 2.

The on-board apparatus advantageously includes a transmitter 60 enabling data to be sent to a mobile telephone or a pocket computer situated in the vicinity of the vehicle, as described below.

In the examples described above, the vehicle is informed about its position by means of the satellites S.

It would not go beyond the ambit of the present invention for the position of the vehicle to be determined in some other manner, e.g. by means of a position-determining system making use of mobile telephone relays or of an on-board computer that records the movement of the vehicle and knows its route.

Such an on-board computer can be connected to an electronic compass and/or a mileage counter.

It can also be connected to inertial navigation equipment, for example.

It is also possible to use a specific position-determining system, e.g. comprising a plurality of transmitter terminals 70 disposed in the various zones Z₁ to Z₅ and each transmitting a specific signal, as shown in FIG. 3.

The transmission range of the terminals 70 is. limited so that a vehicle V in zone Z₁, for example, can pick up only the signal transmitted by the corresponding terminal 70.

The position-determining device 40 then comprises a receiver capable of receiving the signals transmitted by the terminals 70 and of decoding them so as to determine the zone Z₁, . . . , Z₅ in which the vehicle V is situated.

In the above-described examples, the display device is on board a vehicle.

It would not go beyond the ambit of the present invention for the display device to be stationary. By way of example, FIG. 14 shows a stationary display device 10 fixed in a public place such as a shopping center, an airport, or even the street.

In one aspect of the invention, an identifier 80 is displayed on the display device 10 together with the advertising content, thus enabling a user to obtain additional information about the current advertisement.

By way of example, the identifier can be constituted by a telephone number. By dialing this number on a mobile telephone M, an observer can obtain information about the current advertisement, as shown in FIG. 7, said information being delivered by a server 90.

Data can be interchanged between the mobile telephone M and the server 90 using one of the technologies known under the initials WAP, GPRS, 3G, CDMA 2000, or W-CDMA, for example.

In the variant shown in FIG. 8, the additional information is not sent to the mobile telephone M but to the display device 10.

In another variant, shown in FIG. 9, information that can be picked up by a mobile telephone M situated in the vicinity of the vehicle is transmitted, e.g. by means of the transmitter 60 described with reference to FIG. 12, while simultaneously displaying advertising content on the display device 10.

This information can be transmitted using the “Bluetooth” standard, for example.

Thus, a user need only point a mobile telephone M at the vehicle in order to receive additional information relating to the displayed advertising.

The display device can also be connected to a receiver suitable for receiving a request from a person situated in the vicinity of the display device and transmitted by means of a mobile telephone or a portable computer.

By way of example, such a request can correspond to a purchase order for a product corresponding to the displayed advertising.

A person situated in the vicinity of the display device, i.e. in the vicinity of the vehicle when the display device is mounted on a vehicle, can also transmit personal details to the vehicle directly from a mobile telephone, for example can transmit the telephone number of the mobile telephone to a receiver on board the vehicle. optionally, as shown in FIG. 10, the vehicle V transmits a computer network address or a telephone number to the mobile telephone, e.g. the address of an Internet site.

Thereafter, by connecting the mobile telephone M to that address, its user can receive additional information about the advertising in question from a server 90.

The mobile telephone M or portable appliance replacing it may comprise, as shown in FIG. 15, a memory 100 suitable for storing information, in particular information sent by a server.

This information may comprise, for example, elements of text constituted solely by alphanumeric characters, and not constituting a program that is executable by the telephone.

When the mobile telephone M is replaced by a portable computer, e.g. capable of being connected in particular over a wired connection, to an Internet server, these text elements may comprise cookies.

The memory 100 may comprise a hard disk, a CD ROM, a floppy disk, or indeed an electronic memory.

The above-mentioned textual elements are likely to be sent to the memory 100 each time the mobile telephone M is connected to a server, whether or not it is located in the geographical zone associated with the display device 10.

These text elements may contain indications concerning the nature of sites, in particular Internet sites, visited in the past by means of the mobile telephone M. By way of example, these indications may contain the address of a site, the duration of a connection, the speed of a connection, and links to the pages visited.

These textual elements may also comprise indications concerning the nature of operations performed with the appliance, in particular purchases. These indications may, for example, contain the address of the site on which a purchase was performed, a designation of the goods purchased, and the date of purchase.

The text elements may also comprise indications concerning the payment means used with the appliance for paying for the purchases. These indications may relate to a payment order sent in the past and authorizing the sum representing the purchase to be put on the user's telephone bill.

As shown in FIG. 14, the display device 10 may be connected to a detector 110 enabling the presence of one or more mobile telephones M situated in a predetermined geographical zone to be detected.

The detector 110 may be connected to a transceiver 120 which is suitable for sending to a mobile telephone M detected by the detector 110 and ordered to read text elements contained in the memory 100 after receiving a request coming from said telephone.

In a variant, the transceiver 120 may be suitable for sending a read order to a mobile telephone concerning text elements contained in the memory of the telephone even without prior reception of a request coming from said telephone. Thus, the transceiver 120 may gather information about a telephone even when the telephone is in standby mode, or when it is making a call.

The transceiver 120 may be connected to a processor unit 130 suitable for determining the type of information to be sent to the telephone M as a function of information contained in the memory 100 and received by the transceiver 120.

By way of example, the processor unit 130 may be suitable for determining a profile of the user of the telephone on the basis of information read from the memory of the telephone. By way of example, this profile may contain indications about the centers of interest of the user, or about the use that the user makes of the telephone, for example how often the user connects to a computer network such as the Internet.

This profile may also include indications concerning purchases made by means of the telephone together with the method(s) of payment commonly used by the user.

Thus, the transceiver 120 may send information to the user's mobile telephone M relating to the contents displayed on the display device 10 as a function of the profile of the telephone user, such that the information sent to the telephone M is personalized information. In other words, it is easier to send information to a telephone M that is likely to be of interest to the possessor of the telephone.

In another aspect of the invention, when a person decides to purchase a product presented on the display device 10, that person can use the telephone to send a purchase order, in which case the processor unit 130 determines the method of payment that that person favors on the basis of the information read from the memory of the telephone, and then suggests using that method of payment for the current transaction.

Thus, when the information read from the memory indicate that the person is in the habit of paying by debiting a telephone account, the processor unit 130 can propose or even directly instruct payment for the product by debiting the telephone account.

The information sent by the transceiver 120 may comprise an image, alphanumeric characters, a link to an Internet site, or a multimedia content such as music or a film, and transmitted in particular by streaming technology.

The telephone may have a screen 140 for displaying received images.

The transceiver 120 may be connected to a storage space 160 serving to store the information read from the mobile telephone M.

The transceiver 120 may be arranged in such a manner as to determine the length of time a mobile telephone is present in a predetermined geographical zone, for example the zone in which it is possible to read the information displayed on the display device, as a function of the contents displayed on the display device, and to transfer said information to the storage space 160.

The transceiver 120 may also be suitable for determining the length of time mobile telephones are present in a predetermined geographical zone as a function of information read from the memory of said mobile telephone.

The detector 110 may be arranged in such a manner as to determine the number of mobile telephones present in a predetermined geographical zone during a given period of time and to send said information to the storage space 160.

It is also possible to fit the display device with a camera 150 suitable for determining the travel speed of a mobile telephone in the geographical zone as a function of the content displayed, and to send said information to the storage space 160.

The information contained in the storage space 160 may be used in order to perform statistical processing.

The statistical processing may seek to evaluate the interest of passersby through the geographical zone in predetermined displayed content, and also the type of population that is most interested in the displayed content.

Where appropriate, it is thus possible to modify the displayed content in order to maximize impact on people likely to read the information disseminated by the display device.

Returning to the example described with reference to FIGS. 11 and 12, the control means 20 of the display device 10 can be arranged to determine the speed of the vehicle V and to modify the displayed advertising content accordingly.

For example, if the vehicle is traveling slowly or is stationary, then the displayed advertising content can include details that require sustained attention in order to be seen in full.

When the vehicle V is traveling at speed, the displayed content will no longer include such details and will be adapted to being seen by people having very little time to observe the display device 10.

Knowledge of the travel speed of the vehicle V can also be useful for performing additional selection amongst items of advertising content for display so as to take account, for example, of the fact that other road users can be more receptive to a given type of advertising when stuck in a traffic jam.

Naturally, the invention is not limited to the implementations described above.

In particular, the display device can be fitted on vehicles other than those described with reference to FIGS. 4 to 6, in particular to underground trains, surface trains, trams, and even boats.

The mobile telephones described with reference to FIGS. 7 to 10 can be replaced by other mobile appliances, such as pocket computers.

The displayed content can include non-advertising information.

The apparatus on board the vehicle can enable the motorist or the owner of the vehicle to allow the display only of content that satisfies predetermined conditions.

The vehicle can be fitted with means for detecting the approach of a pedestrian or a car for the purpose of triggering the display of an item of content, in particular an advertisement.

The vehicle can also be fitted with a sensor for sensing ambient light levels, enabling the brightness and/or contrast of the display to be adjusted so as to optimize its visibility.

The vehicle can also include at least one video sensor connected to an image processor device for counting the number of times the screen is looked at and the lengths of time that people look at different displayed content, in particular advertising.

In a variant, or in addition, the vehicle can include a counter for measuring the number of requests addressed to the vehicle from mobile telephones or portable computers.

The vehicle can include means suitable for selecting which content, in particular advertising, to display as a function of nearby transmitters, such as mobile telephones, in particular on recognizing subscriptions taken out by the owners of mobile telephones in the vicinity of the vehicle.

The advertising content displayed can thus be matched more closely to the people situated in the vicinity of the vehicle.

1/ A method of sending personalized information to at least one person provided with a portable appliance (M) having a memory (100) and suitable for exchanging information over a wireless connection or for reading information stored in said memory, said method comprising the following steps:
displaying the information by means of at least one display device (10) distinct from the portable appliance and enabling different images to be displayed;
detecting the presence of said appliance (M) in a geographical zone;
during the presence of said appliance in said geographical zone, reading at least one item of information from the memory of the appliance, said item of information having been stored during an earlier use of the appliance or enabling the appliance to be identified; and
sending personalized information to the appliance of content that is a function of said at least one item of information read from the memory and of at least one item of information displayed on the display device, and/or storing the information read from the memories of appliances present in said geographical zone between two predetermined instants.

2/ A method according to claim 1, characterized by the fact that the geographical zone extends at least in the field of view in which the information displayed on the display device can be read visually.

3/ A method according to claim 1 or claim 2, characterized by the fact that the geographical zone is a function of the location of the display device (10).

4/ A method according to any preceding claim, characterized by the fact that the information stored in the memory (100) of the appliance was stored during an earlier use of the appliance (10) while the appliance was outside said geographical zone.

5/ A method according to any preceding claim, characterized by the fact that the geographical zone extends from a point that is fixed in time.

6/ A method according to any one of claims 1 to 4, characterized by the fact that the geographical zone moves during time.

7/ A method according to any preceding claim, characterized by the fact that the memory (100) of the appliance is suitable for exchanging information over a wireless connection with a transmitter and/or a receiver (110) when the appliance is within said geographical zone.

8/ A method according to any preceding claim, characterized by the fact that the appliance is suitable for being connected to at least one server, said memory (100) being capable of containing information sent by the server during an earlier connection of the appliance with said server.

9/ A method according to the preceding claim, characterized by the fact that at least one earlier connection has been implemented over a wired connection.

10/ A method according to any preceding claim, characterized by the fact that the information stored in the memory (100) includes indications concerning the nature of sites, in particular Internet sites, visited in the past by means of said appliance, said indications possibly comprising: a site identity, a site address, answers to a questionnaire, time and date of connection, duration of connection, speed of connection, the addresses of pages visited, the nature of a method of payment used, the identity of the access supplier, the volume of data exchanged.

11/ A method according to any preceding claim, characterized by the fact that the information stored in the memory does not include any program executable by the appliance.

12/ A method according to any preceding claim, characterized by the fact that the portable appliance includes a screen (140).

13/ A method according to any preceding claim, characterized by the fact that the portable appliance is selected from the following list: a mobile telephone (M), a personal digital assistant, a portable computer, in particular an appliance of the mobile Internet terminal type.

14/ A method according to any preceding claim, characterized by the fact that the information sent to the portable appliance includes at least one element selected from the following list: an image, alphanumeric characters, a link to an Internet site, multimedia content transmitted in particular by streaming technology.

15/ A method according to any preceding claim, characterized by the fact that information stored in the memory (100) is caused to be read only after detecting a request sent by the appliance (M).

16/ A method according to any one of claims 1 to 14, characterized by the fact that the information is read in the memory of the appliance independently of prior reception of a request send by the appliance.

17/ A method according to the preceding claim, characterized by the fact that reading is performed while the appliance is in standby mode.

18/ A method according to any preceding claim, characterized by the fact that information stored in the memory of the appliance is read independently of actions undertaken by the user on the appliance.

19/ A method according to any preceding claim, characterized by the fact that information stored in the memory of the appliance is caused to be read independently of the user pressing on a key of the appliance.

20/ A method according to any preceding claim, characterized by the fact that the memory includes at least one of the following elements: a hard disk, a CD ROM, a floppy disk, or an electronic memory of the read/write type or of the read only type.

21/ A method according to any preceding claim, characterized by the fact that the length of time a portable appliance is present in the geographical zone is determined as a function of the content displayed on the display device.

22/ A method according to any preceding claim, characterized by the fact that the length of time a portable appliance is present in the geographical zone is determined as a function of information read from the memory of the appliance and optionally as a function of the displayed content.

23/ A method according to any preceding claim, characterized by the fact that the number of portable appliances detected in the geographical zone during a predetermined period is determined.

24/ A method according to any preceding claim, characterized by the fact that travel speed of the portable appliances in the geographical zone is determined, e.g. by means of a camera.

25/ A method according to any one of claims 21 to 24, characterized by the fact that the information read is stored and used in statistical processing.

26/ A method according to any preceding claim, characterized by the fact that display device is stationary, e.g. constituting an advertising panel.

27/ A method according to any one of claims 1 to 25, characterized by the fact that the display device is moved by means of a vehicle and the display device is configured in such a manner as to be visible to pedestrians or motorists situated in the vicinity of the vehicle.

28/ A method according to the preceding claim, characterized by the fact that the display device displays differing advertising content depending on the location of the vehicle.

29/ A method according to the preceding claim, characterized by the fact that the vehicle is informed about its position by a navigation system.

30/ A method according to claim 28 or claim 29, the vehicle traveling in a city, the method being characterized by the fact that the city is subdivided into a plurality of zones (Z₁, . . . , Z₅) as a function of the preponderance of certain socioeconomic characteristics within the population living or traveling in those zones, in particular purchasing power, religion, average age, customs, and by the fact that different advertising content is displayed appropriate to the characteristics of the population living or traveling in the zone being passed through.

31/ A method according to any one of claims 27 to 30, characterized by the fact that determined content, in particular advertising, is displayed as a function of time of day.

32/ A method according to any one of claims 27 to 31, characterized by the fact that different content, in particular advertising, is displayed as a function of vehicle speed.

33/ A method according to any one of claims 27 to 32, characterized by the fact that different content, in particular advertising, is displayed as a function of traffic density.

34/ A method according to any one of claims 27 to 33, characterized by the fact that on approaching a given store, content, in particular advertising, is displayed relating to the goods or services offered by the store.

35/ A method according to any one of claims 27 to 34, characterized by the fact that at least a portion of the content, in particular advertising, is stored in a data storage device (30) present in the vehicle.

36/ A method according to any one of claims 27 to 35, characterized by the fact that at least a portion of the content, in particular advertising, is downloaded by the vehicle (V).

37/ A method according to the preceding claim, characterized by the fact that advertising content is downloaded practically in real time, a given item of content, in particular advertising, being downloaded on approaching or passing through a zone in which the content is to be displayed.

38/ A method according to any one of claims 27 to 37, characterized by the fact that signals controlling the display of different content, in particular advertising, are sent from transmitter terminals (70) disposed along the route of the vehicle, each item of content, in particular advertising, being specific to one or more given terminals.

39/ A method according to any preceding claim, characterized by the fact that content, in particular advertising, is displayed together with an indication (80) enabling people to obtain additional information about the subject matter of the displayed content and/or to make an order directly, in particular for a product, and/or to send personal details.

40/ A method according to the preceding claim, characterized by the fact that the indication (80) comprises an Internet address.

41/ A method according to any preceding claim, characterized by the fact that data is transferred between the portable appliance (M) and a server using one of the following technologies: WAP, GRPS, 3G, CDMA 2000, or W-CDMA.

42/ A method according to any preceding claim, characterized by the fact that a person perceiving a content, in particular advertising content, is given the option of causing additional information to be displayed on the display device (10) by sending an appropriate request, in particular from the portable appliance.

43/ A method according to any preceding claim, characterized by the fact that data concerning the displayed content is transferred by radio to the portable appliance.

44/ A method according to the preceding claim, characterized by the fact that the transfer by radio of the data takes place using the “Bluetooth” standard.

45/ Apparatus for sending personalized information to at least one person provided with a portable appliance having a memory (100) and suitable for exchanging information over a wireless connection, said apparatus being characterized by the fact that it comprises:
a display device for displaying information, in particular advertising information;
a reader device serving to read at least one item of information contained in said memory while said at least one appliance is present in a geographical zone; and
a transmitter suitable for sending personalized information to the appliance of content that is a function of said at least one item of information read from the memory and as a function of at least one item of information displayed on the display device.

46/ Apparatus according to the preceding claim, characterized by the fact that it includes a detector for detecting the presence of the portable appliance in the field of view in which information displayed on the display device can be read visually.

47/ Apparatus according to either one of the two preceding claims, characterized by the fact that the display device is stationary.

48/ Apparatus according to claim 45 or claim 46, characterized by the fact that the display device is arranged to be fitted on a vehicle and to be easily visible for pedestrians or motorists situated in the vicinity of the vehicle.

49/ Apparatus according to the preceding claim, characterized by the fact that it includes a device for controlling the display device so as to display content, in particular advertising content that differs as a function of the geographical position of the vehicle.

50/ Apparatus according to any one of claims 45 to 49, characterized by the fact that the display device (10) comprises at least one video screen.

51/ Apparatus according to any one of claims 45 to 50, characterized by the fact that the display device comprises at least one microcapsule screen.

52/ Apparatus according to any one of claims 45 to 51, characterized by the fact that the display device comprises at least one scrolling screen.

53/ Apparatus according to any one of claims 45 to 52, characterized by the fact that it includes a position-determining device (40) for determining position by satellite (S).

54/ Apparatus according to claim 49, characterized by the fact that it includes optical, electronic, or magnetic media (30) on which different items of content, in particular advertising, can be or are stored, the control device (20) being arranged to cause a particular item of content, in particular advertising, to be displayed on receiving a specific control signal.

55/ Apparatus according to the preceding claim, characterized by the fact that the specific control signal is delivered automatically by a position-determining device (40).

56/ Apparatus according to claim 55, the display device being fitted on a vehicle, the apparatus being characterized by the fact that the specific control signal is transmitted from outside the vehicle.

57/ Apparatus according to any one of claims 45 to 56 characterized by the fact that it includes a receiver (50) enabling content, in particular advertising, to be downloaded.

58/ Apparatus according to any one of claims 45 to 57, characterized by the fact that the display device does not include audio means.

59/ Apparatus according to any one of claims 45 to 58, characterized by the fact that the display device comprises at least one screen of area lying in the range 0.1 m² to 15 m², preferably in the range 1 m² to 10 m².

60/ Apparatus according to any one of claims 45 to 59, the display device being fitted on a vehicle, the apparatus being characterized by the fact that the control device is arranged to modify the displayed content as a function of the speed of the vehicle.

61/ Apparatus according to any one of claims 45 to 60, characterized by the fact that the transmitter operates by using the “Bluetooth” standard.

62/ Apparatus according to any one of claims 45 to 61, characterized by the fact that the control device is arranged to allow the display only of content satisfying predetermined conditions.

63/ Apparatus according to any one of claims 45 to 62, characterized by the fact that it includes at least one video sensor connected to an image processor device for monitoring the number of times people look at the screen and the length of time they look at it, or a counter for measuring the number of requests sent from a mobile telephone or a portable computer.

64/ Apparatus according to any one of claims 45 to 63, characterized by the fact that the control device is suitable for selecting which content, in particular advertising, to be displayed as a function of nearby transmitters, such as mobile telephones, in particular by recognizing subscriptions taken out by the owners of mobile telephones to be found in the geographical zone.

65/ Apparatus according to any one of claims 45 to 64, characterized by the fact that the control device is connected to means for detecting the approach of a pedestrian or a motorist to enable particular content, in particular advertising, to be displayed.

66/ Apparatus according to any one of claims 45 to 65, characterized by the fact that the control device is connected to a sensor for sensing ambient light level to enable the brightness and/or the contrast of the screen to be adapted to match ambient light.

67/ A system enabling information, in particular advertising, to be displayed, the system being characterized in that it comprises:
at least one vehicle (V) fitted with display means (10) arranged to be easily visible to pedestrians or motorists situated in the vicinity of the vehicle, and a control device (20) for controlling said display device, enabling different content, in particular advertising, to be displayed automatically as a function of the geographical position of the vehicle; and
at least one transmitter (5; 70) external to the vehicle, enabling the control device (20) to cause different content to be displayed in response to a change in the position of the vehicle; and
at least one receiver suitable for receiving a signal transmitted by a mobile telephone or a portable computer in order to place an order or request the display of additional information.

68/ A system according to the preceding claim, characterized by the fact that the transmitter is on board a satellite (S).

69/ A system according to claim 67, characterized by the fact that the transmitter is a relay for a mobile telephone network.

70/ A system according to claim 67, characterized by the fact that the transmitter is a local transmitter terminal (70) specific to the system.

71/ A system according to any one of claims 67 to 70, characterized by the fact that it includes an Internet or voice server (90) external to the vehicle enabling a person who has observed displayed content to obtain additional information thereon.

72/ A system according to any one of claims 67 to 71, characterized by the fact that it includes a transmitter (E) external to the vehicle enabling different advertising content to be sent to the vehicle for display.
